(19) United States
(12) Patent Application Publication
(10) Pub. No.: US 2025/0382311 A1
(43) Pub. Date: Dec. 18, 2025

(54) CO-CATALYST COMPRISING MULTIPLE MAGNESIUM CARBON BONDS

(71) Applicants: COMPAGNIE GENERALE DES ETABLISSEMENTS MICHELIN, CLERMONT-FERRAND Cedex 9 (FR); CENTRE NATIONAL DE LA RECHERCHE SCIENTIFIQUE, PARIS CEDED 16 (FR); ECOLE SUPÉRIEURE DE CHIMIE PHYSIQUE ELECTRONIQUE DE LYON, VILLEURBANNE CEDEX (FR); UNIVERSITÉ CLAUDE BERNARD LYON 1, VILLEURBANNE CEDEX (FR)

(72) Inventors: Nicolas BAULU, CLERMONT-FERRAND Cedex 9 (FR); Christophe BOISSON, TRAMOYES (FR); Franck D'AGOSTO, GENAS (FR); François JEAN-BAPTISTE-DIT-DOMINIQUE, CLERMONT-FERRAND Cedex 9 (FR); Robert NGO, Clermont-Ferrand Cedex 9 (FR); Julien THUILLIEZ, CLERMONT-FERRAND Cedex 9 (FR)

(21) Appl. No.: 18/038,522

(22) PCT Filed: Nov. 19, 2021
(86) PCT No.: PCT/FR2021/052043

§ 371 Date: Dec. 26, 2023

(30) Foreign Application Priority Data
Nov. 24, 2020 (FR) FR2012077

(51) Int. Cl. C07F 3/02

(52) U.S. Cl. CPC C07F 3/02

(57) ABSTRACT

The invention relates to an organomagnesium compound of formula R^{B}—(Mg—R^{A})ₘ—Mg—R^{B}, R^{B} comprising a benzene nucleus substituted with the magnesium atom, one of the carbon atoms of the benzene nucleus ortho to the magnesium being substituted with a methyl, an ethyl or an isopropyl or forming a ring with the carbon atom which is its closest neighbour and which is meta to the magnesium, the other carbon atom of the benzene nucleus ortho to the magnesium being substituted with a methyl, an ethyl or an isopropyl, R^{A} being a divalent aliphatic hydrocarbon-based chain, optionally interrupted with one or more oxygen or sulfur atoms or with one or more arylene groups, m being a number greater than or equal to 1, preferably 1. When used as co-catalyst of a rare-earth metallocene, it allows the synthesis of telechelic polymers.

The field of the present invention is that of organomagnesium compounds that are intended to be used as co-catalysts in catalytic systems that are based on rare-earth metallocenes and used in the preparation of telechelic polyolefins.

In the synthesis of polyolefins by polymerization of an olefin in the presence of a catalytic system which comprises a rare-earth metallocene, in a manner which is well known, the catalytic system comprises a co-catalyst. The co-catalyst is used to activate the metallocene for polymerization. The co-catalyst may be an organolithium, organomagnesium or organoaluminium reagent, for instance as described in patent applications EP 1 092 731, WO 2004/035639, WO 2007/054224 and WO 2018/224776. When the co-catalyst is an organomagnesium reagent, it is typically an organomagnesium chloride or an organomagnesium reagent in which the magnesium atom is bonded to two aliphatic groups, such as dibutylmagnesium, butylethylmagnesium and butyloctylmagnesium.

It is also known that the synthesis of functional polyolefins from these catalytic systems requires a functionalization step. This functionalization step is subsequent to the polymerization reaction and is performed by adding a modifying agent, generally at the end of the polymerization. This first method allows the functionalization of only one chain end of the polymer. An alternative to this first method was to propose the use of functional transfer agents instead of co-catalysts. These functional transfer agents described in patent applications WO 2016/092237 and WO 2013/135314 are, for example, organomagnesium reagents bearing an amine, ether or vinyl function. This alternative indeed makes it possible to omit the additional functionalization step after the polymerization reaction to form functional polymers. However, this alternative leads, like the first method, to the functionalization of only one chain end of the polymer, unless an additional functionalization step is performed at the end of the polymerization. There is therefore concern to find a solution for preparing polyolefins that are functionalized at both chain ends in a process that is efficient and simpler.

The Applicants have discovered a novel organomagnesium compound which contains two magnesium atoms each bonded to a separate carbon atom and constituting a separate specifically substituted benzene nucleus. When the novel organomagnesium compound is used as co-catalyst of a catalytic system based on a rare-earth metallocene in the preparation of polymers, it gives access to the synthesis of telechelic polymers by means of an efficient and simple process.

Thus, a subject of the invention is an organomagnesium compound of formula (I)

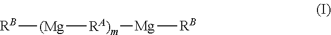

R^{B} being different from R^{A},
R^{B} comprising a benzene nucleus substituted with the magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl,
R^{A} being a divalent aliphatic hydrocarbon-based chain, interrupted or not with one or more oxygen or sulfur atoms or with one or more arylene groups,
m being a number greater than or equal to 1 and preferably equal to 1.

### DESCRIPTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

Unless otherwise indicated, the contents of the units resulting from the insertion of a monomer into a polymer are expressed as a molar percentage relative to the total monomer units that constitute the polymer.

The compounds mentioned in the description may be of fossil origin or may be biobased. In the latter case, they may be partially or totally derived from biomass or may be obtained from renewable starting materials derived from biomass. Similarly, the compounds mentioned may also be derived from the recycling of already-used materials, i.e. they may be partly or totally derived from a recycling process, or obtained from raw materials which are themselves derived from a recycling process.

The term “based on” used to define the constituents of the catalytic system means the mixture of these constituents, or the product of the reaction of a portion or all of these constituents with each other.

The compound in accordance with the invention is an organomagnesium reagent of formula (I) in which R^{B} is different from R^{A}, R^{B} comprises a benzene nucleus substituted with the magnesium atom, one of the carbon atoms of the benzene nucleus ortho to the magnesium being substituted with a methyl, an ethyl or an isopropyl or forming a ring with the carbon atom which is its closest neighbour and which is in the meta position relative to the magnesium, the other carbon atom of the benzene nucleus in the ortho position relative to the magnesium being substituted with a methyl, an ethyl or an isopropyl, R^{A} is a divalent aliphatic hydrocarbon-based chain, interrupted or not with one or more oxygen or sulfur atoms or with one or more arylene groups, m is a number greater than or equal to 1, preferably equal to 1.

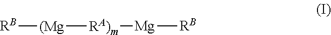

The organomagnesium reagent of formula (I) is thus characterized in that it comprises two magnesium atoms, each magnesium atom being bonded to two carbon atoms. In the organomagnesium reagent of formula (I), two magnesium atoms each share a first bond with a first carbon atom belonging to R^{B} and a second bond with a second carbon atom belonging to R^{A}. The first carbon atom is a constituent of the benzene nucleus of R^{B}. The second carbon atom is a constituent of the aliphatic hydrocarbon-based chain R^{A} which may contain within its chain one or more heteroatoms chosen from oxygen and sulfur or one or more arylene groups. In the preferential case where m is equal to 1, each magnesium atom thus shares a first bond with a first carbon atom of R^{B} and a second bond with a second carbon atom of R^{A}.

R^{B} has the essential feature of comprising a benzene nucleus substituted with the magnesium atom. The two carbon atoms of the benzene nucleus of R^{B} ortho to the magnesium bear an identical or different substituent. Alternatively, one of the two carbon atoms of the benzene nucleus of R^{B} ortho to the magnesium may bear a substituent, and the other carbon atom of the benzene nucleus of R^{B} ortho to the magnesium may form a ring. The substituent is a methyl, an ethyl or an isopropyl. In the case where one of the two carbon atoms of the benzene nucleus of R^{B} ortho to the magnesium is substituted with an isopropyl, the second carbon atom of the benzene nucleus of R^{B} ortho to the magnesium is preferably not substituted with an isopropyl. Preferably, the carbon atoms of the benzene nucleus of R^{B} ortho to the magnesium are substituted with a methyl or an ethyl. More preferentially, the carbon atoms of the benzene nucleus of R^{B} ortho to the magnesium are substituted with a methyl.

According to a preferential embodiment of the invention, the organomagnesium reagent corresponds to formula (II-m) in which m is greater than or equal to 1, R₁ and R₅, which are identical or different, represent a methyl or an ethyl, preferably a methyl, R₂, R₃ and R₄, which are identical or different, represent a hydrogen atom or an alkyl and R^{A} is a divalent aliphatic hydrocarbon-based chain, interrupted or not with one or more oxygen or sulfur atoms or with one or more arylene groups. Preferably, R₁ and R⁵ represent a methyl. Preferably, R₂ and R₄ represent a hydrogen atom.

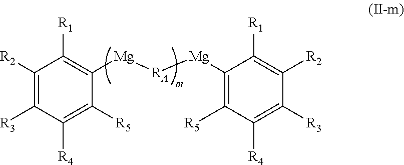

The organomagnesium reagent of formula (II-m) is of formula (II-1) in the case where m is equal to 1.

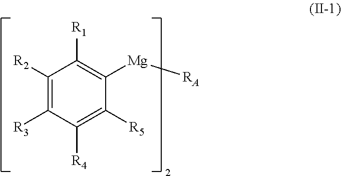

According to a preferential variant, R₁, R₃ and R₅ are identical in formula (II-m), notably in formula (II-1). According to a more preferential variant, R₂ and R₄ represent a hydrogen and R₁, R₃ and R⁵ are identical. In a more preferential variant, R₂ and R₄ represent a hydrogen and R₁, R₃ and R₅ represent a methyl.

In formulae (I) and (II-m), in particular in formula (II-1), R^{A} is a divalent aliphatic hydrocarbon-based chain which may contain within its chain one or more heteroatoms chosen from oxygen and sulfur or one or more arylene groups. Preferably, R^{A} is a branched or linear alkanediyl, cycloalkanediyl or xylenediyl radical. More preferentially, R^{A} is an alkanediyl. Preferably, R^{A} contains 3 to 10 carbon atoms, in particular 3 to 8 carbon atoms. Even more preferentially, R^{A} is an alkanediyl containing 3 to 10 carbon atoms. Advantageously, R^{A} is an alkanediyl containing 3 to 8 carbon atoms. Very advantageously, R^{A} is a linear alkanediyl. 1,3-propanediyl, 1,4-butanediyl, 1,5-pentanediyl, 1,6-hexanediyl, 1,7-heptanediyl and 1,8-octanediyl are most particularly suitable as groups R^{A}.

According to any one of the embodiments of the invention, m is preferentially equal to 1 in formula (I), in particular in formula (II-m).

The organomagnesium compound in accordance with the invention may be prepared via a process which comprises the reaction of a first organomagnesium reagent of formula XMg—R^{A}—MgX with a second organomagnesium reagent of formula R^{B}—Mg—X, in which X represents a halogen atom, preferentially bromine or chlorine, R^{B} and R^{A} being as defined previously. X is more preferentially a bromine atom. The stoichiometry used in the reaction determines the value of m in formula (I) and in formula (II-m). For example, a mole ratio of 0.5 between the amount of the first organomagnesium reagent and the amount of the second organomagnesium reagent is favourable to the formation of an organomagnesium compound of formula (I) in which m is equal to 1, whereas a mole ratio of greater than 0.5 will be more favourable to the formation of an organomagnesium compound of formula (I) in which m is greater than 1.

To perform the reaction of the first organomagnesium reagent with the second organomagnesium reagent, a solution of the second organomagnesium reagent is typically added to a solution of the first organomagnesium reagent. The solutions of the first organomagnesium reagent and the second organomagnesium reagent are generally solutions in an ether, such as diethyl ether, dibutyl ether, tetrahydrofuran, methyltetrahydrofuran, or a mixture of two or more of these ethers. Preferably, the respective concentrations of the solutions of the first organomagnesium reagent and the second organomagnesium reagent are from 0.01 to 3 mol/L and from 0.02 to 5 mol/L, respectively. More preferentially, the respective concentrations of the first organomagnesium reagent and the second organomagnesium reagent are from 0.1 to 2 mol/L and from 0.2 to 4 mol/L, respectively.

The first organomagnesium reagent and the second organomagnesium reagent may be prepared beforehand by a Grignard reaction from magnesium metal and a suitable precursor. For the first organomagnesium reagent and the second organomagnesium reagent, the respective precursors are of formula X—R^{A}—X et R^{B}—X, R^{A}, R^{B} and X being as defined previously. The Grignard reaction is typically performed by adding the precursor to magnesium metal which is generally in the form of chips. Preferably, iodine (I₂) typically in the form of beads is introduced into the reactor prior to the addition of the precursor to activate the Grignard reaction in a known manner.

Alternatively, the organomagnesium compound in accordance with the invention may be prepared by reacting an organometallic compound of formula M-R^{A}-M and the organomagnesium reagent of formula R^{B}—Mg—X, where M represents a lithium, sodium or potassium atom, X, R^{B} and R^{A} being as defined previously. Preferably, M represents a lithium atom, in which case the organometallic compound of formula M-R^{A}-M is an organolithium reagent.

The reaction of the organolithium reagent and of the organomagnesium reagent is typically performed in an ether such as diethyl ether, dibutyl ether, tetrahydrofuran or methyltetrahydrofuran. The reaction is also typically performed at a temperature ranging from 0° C. to 60° C. The placing in contact is preferably performed at a temperature of between 0° C. and 23° C. The placing in contact of the organometallic compound of formula M-R^{A}-M with the organomagnesium reagent of formula R^{B}—Mg—X is preferentially performed by adding a solution of the organometallic compound M-R^{A}-M to a solution of the organomagnesium reagent R^{B}—Mg—X. The solution of the organometallic compound M-R^{A}-M is generally a solution in a hydrocarbon-based solvent, preferably n-hexane, cyclohexane or methylcyclohexane, and the solution of the organomagnesium reagent R^{B}—Mg—X is generally a solution in an ether, preferably diethyl ether or dibutyl ether. Preferably, the respective concentrations of the solutions of the organometallic compound and of the organomagnesium reagent M-R^{A}-M and R^{B}—Mg—X are from 0.01 to 1 mol/L and from 0.02 to 5 mol/L, respectively. More preferentially, the respective concentrations of the solutions of the organometallic compound and of the organomagnesium reagent M-R^{A}-M and R^{B}—Mg—X are from 0.05 to 0.5 mol/L and from 0.2 to 3 mol/L, respectively.

As with any synthesis performed in the presence of organometallic compounds, the syntheses described for the synthesis of the organomagnesium reagents that are useful for the purposes of the invention and for the synthesis of the organomagnesium reagent in accordance with the invention, take place under anhydrous conditions under an inert atmosphere, in stirred reactors. Typically, the solvents and the solutions are used under anhydrous nitrogen or argon.

Once the organomagnesium reagent according to the invention has been formed, it is generally recovered in solution after filtration performed under an inert anhydrous atmosphere. The solution of the organomagnesium reagent according to the invention is typically stored prior to use in sealed containers, for example capped bottles, at a temperature of between −25° C. and 23° C.

Like any organomagnesium compound, the organomagnesium compound R^{B}—(Mg—R^{A})ₘ—Mg—R^{B} in accordance with the invention may be in the form of a monomeric species (R^{B}—(Mg—R^{A})ₘ-Mg—R^{B}) 1 or in the form of a polymeric species (R^{B}—(Mg—R^{A})ₘ-Mg—R^{B})ₚ, where p is an integer greater than 1, notably dimer (R^{B}—(Mg—R^{A})ₘ-Mg—R^{B})₂, where m is as defined previously. Moreover, whether it is in the form of a monomer or polymer species, it may also be in the form of a species coordinated to one or more molecules of a solvent, preferably of an ether such as diethyl ether, tetrahydrofuran or methyltetrahydrofuran.

The organomagnesium compound according to the invention is most particularly intended for use as a co-catalyst in a catalytic system comprising an organometallic complex and useful for the polymerization or copolymerization of olefins or dienes. The organometallic complex is typically a rare-earth metallocene or hemimetallocene. The organomagnesium compound in accordance with the invention has the role of activating the organometallic complex towards the polymerization reaction, notably in the polymerization initiation reaction. It may replace the co-catalyst of the catalytic systems described, for example, in EP 1092731 A1, WO 2004/035639 A1, WO 2005/028526 A1, WO 2007/045223 A2 or WO 2007/045224 A2. It may also replace the co-catalyst of “preformed” catalytic systems in the presence of a monomer and described, for example, in WO 2017/093654 A1, WO 2018/020122 A1 and WO 2018/100279 A1.

When used as co-catalyst in such catalytic systems, the organomagnesium compound in accordance with the invention allows the synthesis of telechelic polymers of 1,3-dienes, ethylene or α-monoolefins. The term “α-monoolefin” means an α-olefin which contains a single carbon-carbon double bond, the double bonds in aromatic compounds not being taken into account. For example, styrene is considered an α-monoolefin. α-Monoolefins that may particularly be mentioned include those containing from 3 to 18 carbon atoms. 1,3-Dienes, more particularly 1,3-dienes containing from 4 to 24 carbon atoms, are very particularly suitable as conjugated dienes. Preferably, the 1,3-diene is 1,3-butadiene, isoprene or a mixture thereof.

Telechelic polymers have the essential feature of having a carbon-magnesium bond at their ends. They may be represented by formula (III) in which R^{A} and R^{B} are defined as previously, and the term poly denoting a polymer chain resulting from the polymerization of conjugated dienes, notably of 1,3-dienes, ethylene, α-monoolefins or mixtures thereof.

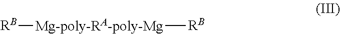

The telechelic polymers which have a carbon-magnesium bond at their ends are able to react with a modifying agent to give rise to the formation of polymers functionalized at the ends. The modifying agent is typically a compound known to react with a compound containing a carbon-magnesium bond. Modifying agents that are particularly suitable for use are dihalogens and ketones. The functions at the ends of the functionalized polymer are advantageously identical. Thus, via a simple process which comprises a polymerization reaction and a reaction with a modifying agent, the organomagnesium reagent according to the invention used in conjunction with a metallocene gives access to the synthesis of polymers whose two ends bear identical functional groups.

By reaction with labelled compounds, telechelic polymers which have a carbon-magnesium bond at their ends also have the ability to give rise to the formation of chains whose two ends are labelled with an isotope, for example, an isotope of the hydrogen atom such as deuterium. Labelled compounds are, for example, deuterated water, compounds with a deuterated alcohol function. Thus, by a simple process which comprises a polymerization reaction and a termination reaction with a labelled protic compound such as deuterated water or an alcohol containing a deuterated alcohol function, the organomagnesium reagent in accordance with the invention used in conjunction with a metallocene gives access to the synthesis of polymers whose two ends are labelled with an isotope of the hydrogen atom.

Furthermore, the use in a catalytic system of a compound of formula (I) in which at least one of the two carbon atoms of the benzene ring of R^{B} ortho to the magnesium is not substituted with isopropyl, also has the advantage of leading to high catalytic activities. Therefore, the use in a catalytic system of an organomagnesium reagent which is in accordance with the invention and in which at least one of the two carbon atoms of the benzene ring of R^{B} ortho to magnesium is not substituted with isopropyl, allows the synthesis of telechelic polymers with high productivity due to high catalytic activity.

The abovementioned features of the present invention, and also others, will be understood more clearly on reading the following description of implementation examples of the invention, which are given as non-limiting illustrations.

### EXAMPLES

### Example 1: Preparation of a Co-Catalyst in Accordance with the Invention, 1,5-di(mesitylmagnesium)pentanediyl (DMMP)

The toluene and 2-methyltetrahydrofuran (MeTHF) used in the syntheses were distilled over sodium/benzophenone. Inertization was performed by three vacuum/argon cycles.

Synthesis of 2-mesitylmagnesium bromide: 4.15 g (170 mmol, 3.4 equivalents) of magnesium are inertized in a 250 mL flask fitted with a magnetized olive and mounted with a 10 mL dropping funnel.

A diiodine bead (10 mg) is added to the magnesium. 47.5 ml of MeTHF are placed in the flask with stirring and 2.5 ml are placed in the dropping funnel. 7.65 mL of degassed 2-bromomesitylene (50 mmol, 1 equivalent) dried over activated molecular sieves are placed in the dropping funnel. The flask is heated to 60° C. and the 2-bromomesitylene is added dropwise to the magnesium over 1 hour. Stirring is continued for 3 h at 60° C. and then for 12 h at 20° C.

Aliquot of the concentrated oil in a Young's tube: ¹H NMR (C₆D₆-400 MHZ-298 K) δ: ppm=7.01 (s, “a”), 2.74 (s, “b”), 2.36 (s, “c”)

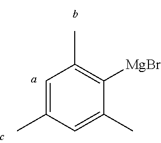

Synthesis of 1,5-di(magnesium bromide)pentanediyl: 6.17 g (250 mmol, 10 equivalents) of magnesium are inertized in a 250 ml flask fitted with a magnetized olive and mounted with a 50 ml dropping funnel. A diiodine bead (10 mg) is added to the magnesium. 10 mL of MeTHF are placed in the flask with stirring and 40 ml are placed in the dropping funnel. 3.41 mL of 1,5-dibromopentane (25 mmol, 1 equivalent) degassed and dried over activated molecular sieves are placed in the dropping funnel. The haloalkane solution is poured dropwise onto the magnesium over 1 h. Stirring is continued for 12 h at 20° C.

Aliquot of the concentrated oil in a Young's tube: ¹H NMR (C₆D₆-400 MHz-298 K) δ: ppm=2.06 (quint, J=7.6 Hz, “b”), 1.80 (quint, J=7.4 Hz, “c”), −0.05 (t, J=7.7 Hz, “a”); quint for quintet.

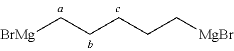

Synthesis of 1,5-di(mesitylmagnesium)pentanediyl: The preceding solution of 2-mesitylmagnesium bromide is cannulated, i.e. transferred via a cannula, into the 1,5-di(magnesium bromide)pentanediyl solution. 20 ml of MeTHF and 10.3 mL 1,4-dioxane (120 mmol, 1.2 equivalents/Mg) are placed in the dropping funnel. This solution is poured into the flask dropwise over 1 h with vigorous stirring. Stirring is continued for 20 h at 20° C. The stirring is stopped and the flask is set aside for 24 h to allow the MgBr₂ salts to settle out completely. The supernatant is transferred via the filter cannula into an inertized Schlenk tube, which is fitted with a frit on which 1 cm of calcined celite has been placed, for filtration. Once the salts have been removed, the yellow solution obtained is concentrated under vacuum to give an oil with a mass of 17.88 g (23 mmol as pentanediyl group according to ¹H NMR estimations). 15.75 mL of toluene are added to 9.1 g (11.7 mmol) of the oil with stirring to give a dilute solution with a concentration of 0.45 mol L⁻¹ of pentanediyl group. The density of the concentrated oil was estimated to be 1 g mL-1.

Aliquot of the concentrated oil: ¹H NMR (C₆D₆-500 MHZ-340 K) δ: ppm=6.90 (s, “d”), 2.54 (s, “e”), 2.29 (s, “f”), 2.20 (quint, J=6.5 Hz, “b”), 1.82 (quint, J=6.0 Hz, “c”), 0.10 (t, J=7.2 Hz, “a”)

¹³C NMR (C₆D₆-500 MHZ-340 K) 8: ppm=161.00 (“g”), 148.30 (“h”), 135.18 (“i”), 125.74 (“d”), 28.53 (“b”), 28.53 (“c”), 28.11 (“e”), 21.46 (“f”), 10.22 (“a”)

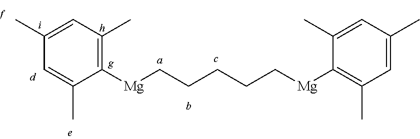

High resolution NMR spectroscopy of organometallic compounds and their precursors was performed on a Brüker 400 Avance Ill spectrometer operating at 400 MHz equipped with a 5 mm BBFO probe or on a Brüker 500 Avance III spectrometer operating at 500 MHz equipped with a 5 mm BBFO probe. Acquisitions were made at 298 K or 340 K in deuterated benzene (C₆D₆). The samples were analysed at a concentration of 5% by mass. The chemical shifts are given in ppm, relative to the C₆D₆ proton signal set at 7.16 ppm and the carbon signal set at 128.06 ppm.

The structure of the diorganomagnesium compounds is characterized by 1D 1H, ¹H-¹³C HSQC ((Heteronuclear Single Quantum Coherence), ¹H-¹³C HMBC (Heteronuclear Multiple-Bond Correlation) nuclear magnetic resonance NMR and NOESY. The diorganomagnesium compound is analysed with its synthesis solvent and deuterated benzene (C₆D₆) is added to the solution to obtain the NMR “lock”.

### Example 2: Preparation of a Co-Catalyst not in Accordance with the Invention, 1,5-di(magnesium bromide)pentanediyl (DBMP)

9.72 g of magnesium (400 mmol, 10 equivalents), 80 mL of MeTHF (of which 64 mL in the dropping funnel), 60 mg of diiodine (0.23 mmol, 0.006 equivalent) and 5.45 ml of 1,5-dibromopentane (40 mmol, 1 equivalent) were used in the synthesis. The glassware used consisted of a 200 mL flask and a 100 mL dropping funnel. Once the synthesis of the Grignard reagent was complete, the solution is cannulated through the filter cannula into a second inertized 200 mL flask. This solution is concentrated under vacuum and then diluted in 55 mL of toluene. The concentration of pentanediyl group is estimated at 0.43 mol L′1. This oil is immiscible in methylcyclohexane.

Aliquot of the concentrated oil: ¹H NMR (toluene-D₈-500 MHZ-298 K) δ: ppm=2.21 (quint, J=7.2 Hz, “b”), 1.88 (quint, J=7.0 Hz, “c”), 0.11 (t, J=7.4 Hz, “a”)

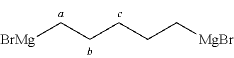

### Synthesis of Telechelic and Functional Polymers:

Ethylene homopolymers and ethylene-butadiene copolymers were prepared from the complex {(Me₂Si(C₁₃H₈)₂)Nd(—BH₄)[(—BH₄)Li(THF)]}₂ and the co-catalyst di(mesitylmagnesium)pentanediyl (DMMP) prepared according to the procedure described previously. Polymers were also synthesized using a co-catalyst not in accordance with the invention, 1,5-di(magnesium bromide)pentanediyl (DBMP). The polymers were characterized using the methods described hereinbelow.

High temperature size exclusion chromatography (HT-SEC). The high temperature size exclusion chromatography (HT-SEC) analyses were performed with a Viscotek machine (Malvern Instruments) equipped with three columns (PLgel Olexis 300 mm×7 mm I. D. from Agilent Technologies) and three detectors (differential refractometer and viscometer, and light scattering). 200 μL of a solution of the sample at a concentration of 3 mg mL⁻¹ were eluted in 1,2,4-trichlorobenzene using a flow rate of 1 mL min 1 at 150° C. The mobile phase was stabilized with 2,6-di(tert-butyl)-4-methylphenol (400 mg L⁻¹). OmniSEC software was used for data acquisition and analysis. The molar masses of the synthesized polyethylenes were calculated using a calibration curve obtained from standard polyethylenes (peak molar mass Mₚ: 338, 507, 770, 1890, 17 000, 27 300, 43 400, 53 100, 65 700, 78 400 g·mol⁻¹) from Polymer Standard Service (Mainz). The number-average molar mass (Mn) and mass-average molar mass (Mw) of the synthesized ethylene-butadiene copolymers were calculated using a universal calibration curve calibrated from standard polystyrenes (Mₚ: 672 to 12 000 000 g mol⁻¹) from Polymer Standard Service (Mainz) using refractometric and viscometric detectors.

THE size exclusion chromatography (THF-SEC). The size exclusion chromatography analyses were performed with a Viscotek machine (Malvern Instruments). This machine is equipped with three columns (SDVB, 5 μm, 300×7.5 mm from Polymer Standard Service), a guard column and three detectors (differential refractometer and viscometer, and light scattering). 3 mL of a solution of the sample with a concentration of 3 mg mL⁻¹ in THF were filtered through a 0.45 μm PTFE membrane. 100 μL of this solution were eluted in THE using a flow rate of 1 mL min 1 at a temperature of 35° C. OmniSEC software was used for data acquisition and analysis. The number-average molar mass (Mn) and mass-average molar mass (Mw) of the synthesized ethylene-butadiene copolymers were calculated using a universal calibration curve obtained from standard polystyrenes (peak molar mass Mₚ: 1306 to 2 520 000 g mol-1) from Polymer Standard Service (Mainz).

Nuclear magnetic resonance (NMR). High resolution NMR spectroscopy of the polymers was performed on a Brüker 400 Avance III spectrometer operating at 400 MHz equipped with a 5 mm BBFO probe for the proton and on a Brüker 400 Avance II spectrometer operating at 400 MHz equipped with a 10 mm PSEX ¹³C probe for the carbon. Acquisitions were made at 363 K. A mixture of tetrachloroethylene (TCE) and deuterated benzene (C₆D₆) (2/1 v/v) was used as solvent. The samples were analysed at a concentration of 1% by mass for proton and 5% by mass for carbon. The chemical shifts are given in ppm, relative to the deuterated benzene proton signal set at 7.16 ppm and the TCE carbon signal set at 120.65 ppm. The sequence used to acquire a ¹³C spectrum of a polymer is:

“Power gate decoupling” (NOE proton-decoupled spectrum) with a pulse angle of 70°, DT=64 K and a delay between pulses of 4.5 s. The number of acquisitions is set at 5120.

### Synthesis of Telechelic and Functional Polyethylenes:

### Example PE1

200 ml of toluene distilled over sodium/benzophenone are placed in an inertized 250 mL flask fitted with a magnetized olive.

2.0 mL (0.90 mmol) of 1,5-di(mesitylmagnesium)pentanediyl prepared according to Example 1 (0.45 mol L′1 in toluene) are added to the flask with stirring. 8.0 mg (12.5 μmol as neodymium) of {(Me₂Si(C₁₃H₈)₂)Nd(—BH₄)[(—BH₄)Li(THF)]}₂ are then added to the flask.

The catalytic solution is cannulated into a 250 ml reactor under an inert atmosphere. The argon excess pressure in the reactor is reduced to 0.5 bar and the reactor is then pressurized to 4 bar of ethylene and the temperature is simultaneously brought to 70° C. The pressure is kept constant in the reactor by means of a tank containing ethylene.

When the desired amount of ethylene has been consumed, in this case after 19 min, the reactor is degassed and the temperature is reduced to 20° C. 20% of the polymer solution is cannulated out of the reactor and the polymer contained in this 20% is then precipitated from methanol with stirring. 5.86 g (23 mmol, 16 equivalents/Mg) of diiodine dissolved in 30 ml of toluene are added to the polymer solution remaining in the reactor. After 3 h of stirring, the polymer solution is poured onto methanol with stirring to precipitate the polymer.

The polymer recovered after the reaction with the modifying agent (PE1F) is filtered off, washed with methanol, dried and characterized. It is denoted as PE1F.

The polymer precipitated from methanol prior to the addition of the modifying agent is also recovered by filtration and dried before being characterized as non-functional polymer (PE1NF).

1.13 g of PE1F polymer of formula I—(CH₂—CH₂)ₙ—(CH₂)₅—(CH₂—CH₂)ₙ—I and 0.25 g of PE1NF polymer of formula H—(CH₂—CH₂)ₙ—(CH₂)₅—(CH₂—CH₂)ₙ—H are recovered.

The proton NMR spectrum of the PE1F polymer (TCE/C₆D₆ 2/1 v/v, 400 MHZ, 363 K) shows methylene in the α-position of iodine at δ=2.95 ppm (triplet, (CH₂CH₂)ₙ—CH₂I). The degree of functionalization in the PE1F polymer is calculated by determining the content of non-functionalized chains in the polymer. The content of non-functionalized chains in PE1F is determined by normalizing the integrals of the (CH₂CH₂)ₙ signals of the two ¹H NMR spectra to 100 and then dividing the integral of the CH₃ signals of the PE1F polymer by that of the CH₃ signals of the PE1NF polymer. Thus, in PE1F, 13% of the polymer chain ends are non-functional, and thus 87% of the polymer chain ends have been functionalized with an iodine atom.

### Example PE2

The synthesis of the telechelic polymer is similar to that performed in the preceding example PE1, except that 4.0 ml (1.80 mmol) of 1,5-di(mesitylmagnesium)pentanediyl prepared according to Example 1 (0.45 mol L⁻¹ in toluene) and 10.0 mg (15.6 μmol of neodymium) of {(Me₂Si(C₁₃H₈)₂)Nd(—BH₄)[(—BH₄)Li(THF)]}₂ are used to prepare the catalytic solution.

When the desired amount of ethylene has been consumed, in this case after 46 min, the reactor is degassed and the temperature is reduced to 20° C. 50% of the polymer solution is cannulated out of the reactor and the polymer (PE2NF) contained in this 50% is then precipitated from methanol with stirring.

2.0 mL (44 mmol, 11 equivalents/Mg) of deuterated methanol diluted in 5 mL of toluene are added to the polymer solution remaining in the reactor. After 1 h of stirring, the polymer solution is poured onto methanol with stirring to precipitate the PE2M polymer.

Each precipitated polymer was filtered off, washed with methanol and then dried. 1.03 g of PE2M polymer: D-(CH₂—CH₂)—(CH₂)—(CH₂—CH₂)ₙ-D and 1.00 g of PE2NF polymer: H—(CH₂—CH₂)—(CH₂)—(CH₂—CH₂)ₙ—H are recovered.

The proton NMR spectrum of the PE2M polymer (TCE/C₆D₆ 2/1 v/v, 400 MHZ, 363 K) allows the observation of methylene in the α-position of deuterium at δ=0.83 (broad, −CH₂D)).

The degree of labelling in the PE2M polymer is calculated by determining the content of unlabelled chains in the polymer. The content of unlabelled chains in PE2M is determined by normalizing the integrals of the (CH₂CH₂)ₙ signals of the two ¹³C NMR spectra to 100 and then dividing the integral of the CH₃ signals of the PE2M polymer by that of the CH₃ signals of the PE2NF polymer. Thus in PE2M, 9% of the polymer chain ends are unlabelled, and thus 91% of the polymer chain ends have been labelled with a deuterium atom.

### Example PE3

The synthesis of the telechelic polymer is similar to that performed in the preceding Example PE2, except that 3.0 ml (1.35 mmol) of 1,5-di(magnesium bromide)pentanediyl prepared according to Example 2 (0.45 mol L⁻¹ in toluene) and 10.0 mg (15.6 μmol neodymium) of {(Me₂Si(C₁₃H₃)₂)Nd(—BH₄)[(—BH₄)Li(THF)]}₂ are used to prepare the catalytic solution. The co-catalyst used is a co-catalyst not in accordance with the invention.

When the desired amount of ethylene has been consumed, in this case after 49 min, the reactor is degassed and the temperature is reduced to 20° C. 40% of the polymer solution is cannulated out of the reactor, and the polymer contained in this 40% is then precipitated from methanol with stirring.

2.0 mL (44 mmol, 15 equivalents/Mg) of deuterated methanol diluted in 5 mL of toluene are added to the polymer solution remaining in the reactor. After 1 h of stirring, the polymer solution is poured onto methanol with stirring to precipitate the polymer.

Each polymer is filtered off, washed with methanol and then dried. 1.14 g of PE3M polymer: D-(CH₂—CH₂)ₙ—(CH₂)₅—(CH₂—CH₂)ₙ-D and 0.70 g of PE3NF polymer: H—(CH₂—CH₂)ₙ—(CH₂)₅—(CH₂—CH₂)ₙ—H are recovered.

The proton NMR spectrum of the PE3M polymer (TCE/C₆D₆ 2/1 v/v, 400 MHz, 363 K) allows the observation of methylene in the α-position of deuterium at δ=0.83 (broad, −CH₂D)).

The degree of labelling in the PE3M polymer is calculated by determining the content of unlabelled chains in the polymer. The content of unlabelled chains in PE3M is determined by normalizing the integrals of the (CH₂CH₂)ₙ signals of the two ¹³C NMR spectra to 100 and then dividing the integral of the CH₃ signals of the PE3M polymer by that of the CH₃ signals of the PE3NF polymer. Thus in PE3M, 11% of the polymer chain ends are unlabelled, and thus 89% of the polymer chain ends have been labelled with a deuterium atom.

The conditions for the polymerization of ethylene are given in Table 1. Table 1 also shows for each example the catalytic activity calculated over the entire polymerization time and expressed in Kg·mol⁻¹·h⁻¹. The characteristics of the synthesized polyethylenes are shown in Table 2. The HT-SEC method was used.

Synthesis of telechelic and functional copolymers of ethylene and 1,3-butadiene:

### Example EBR1

200 ml of toluene purified on an activated alumina column (also known as a solvent fountain) are placed in an inertized 250 mL flask equipped with a magnetized olive. 2.2 mL (1.0 mmol) of 1,5-di(mesitylmagnesium)pentanediyl prepared according to Example 1 (0.45 mol L⁻¹ in toluene) are added to the flask with stirring. 32.0 mg (50 μmol as neodymium) of {(Me₂Si(C₁₃H₈)₂)Nd(—BH₄)[(−BH₄)Li(THF)]}₂ are then added to the flask.

The catalytic solution is cannulated into a 250 mL reactor under an inert atmosphere. The argon excess pressure in the reactor is reduced to 0.5 bar, and the reactor is then pressurized to 4 bar with an 80/20 molar ethylene/butadiene mixture and the temperature is simultaneously brought to 70° C. The pressure is kept constant in the reactor by means of a tank containing an 80/20 molar ethylene/butadiene gas mixture.

The reactor is degassed when 10 g of the target monomers are consumed, in this case after 145 min, and the temperature is reduced to 20° C.

To determine the microstructure and macrostructure of the telechelic polymer, the polymer solution is poured onto methanol with stirring to precipitate the polymer. The polymer is washed with methanol and then dried. 10.50 g of polymer are recovered.

### Example EBR2

The synthesis of the telechelic polymer is similar to that performed in the preceding example EBR1, except that 1.1 mL (0.5 mmol) of 1,5-di(mesitylmagnesium)pentanediyl prepared according to Example 1 (0.45 mol L⁻¹ in toluene) are used to prepare the catalytic solution.

10 g of the target monomers are consumed after 112 min of polymerization. 10.33 g of polymer are actually recovered.

### Example EBR3

The synthesis of the telechelic polymer is similar to that performed in the preceding example EBR1, except that 0.55 mL (0.25 mmol) of 1,5-di(mesitylmagnesium)pentanediyl prepared according to Example 1 (0.45 mol L⁻¹ in toluene) are used to prepare the catalytic solution.

10 g of the target monomers are consumed after 86 min of polymerization. 10.66 g of polymer are actually recovered.

### Example EBR4

The synthesis of the telechelic polymer is similar to that performed in the preceding Example EBR1, except that 2.3 mL (1.0 mmol) of 1,5-di(magnesium bromide)pentanediyl prepared according to Example 2 (0.43 mol L⁻¹ in toluene) are used as co-catalyst to prepare the catalytic solution. The co-catalyst used is a co-catalyst not in accordance with the invention.

10 g of the target monomers are consumed after 175 min of polymerization. 10.57 g of polymer are recovered.

### Example EBR5

The synthesis of the telechelic polymer is similar to that performed in the preceding example EBR4, except that 1.15 ml (0.5 mmol) of 1,5-di(magnesium bromide)pentanediyl prepared according to Example 2 (0.43 mol L⁻¹ in toluene) are used as co-catalyst to prepare the catalytic solution. The co-catalyst used is a co-catalyst not in accordance with the invention.

10 g of the target monomers are consumed after 129 min of polymerization. 9.50 g of polymer are actually recovered.

### Example EBR6

The synthesis of the telechelic polymer is similar to that performed in the preceding example EBR4, except that 0.58 mL (0.25 mmol) of 1,5-di(magnesium bromide)pentanediyl prepared according to Example 2 (0.43 mol L⁻¹ in toluene) are used as co-catalyst to prepare the catalytic solution. The co-catalyst used is a co-catalyst not in accordance with the invention.

10 g of the target monomers are consumed after 105 min of polymerization. 10.06 g of polymer are actually recovered.

The conditions for the copolymerization of ethylene and 1,3-butadiene are given in Table 3. The catalytic activity expressed in Kg·mol⁻¹·h⁻¹ is measured for each example at 80 minutes of polymerization and is shown in Table 3. The characteristics of the synthesized copolymers are shown in Table 4. The THF-SEC method was used for polymers EBR1 to EBR3; the HT-SEC method was used for polymers EBR4 to EBR6. The mole content of ethylene and 1,3-butadiene inserted into the chain of the copolymers is determined by NMR.

### Results

The results show that the use of an organomagnesium reagent in accordance with the invention such as DMMP allows the synthesis of telechelic polymers by polymerization of an olefin such as ethylene or a 1,3-diene such as 1,3-butadiene, and also by their copolymerization. The telechelic nature is shown in particular on the one hand by marking the polymer ends by reaction with deuterated methanol (PE2M), and on the other hand by functionalizing them with iodine (PE1F). The telechelic nature is high, taking into consideration the degrees of functionalization after reaction with diiodine (87%) and considering the content of labelled polymer (Table 2, degree of labelling: 91%) and the average number of deuterated ends per polymer chain (Table 2, labelled end per chain: 1.8 for a theoretical value of 2).

Moreover, both for the synthesis of homopolymers and for the synthesis of copolymers, it is noted that the catalytic activity of the catalytic system is much higher with the use of a co-catalyst in accordance with the invention than with the use of a non-compliant co-catalyst.

TABLE 1

| | | Mg/Nd | Modifying | | |
|---|---|---|---|---|---|
| | Co- | mole | agent or protic | Time | Activity |
| Polymer | catalyst | ratio | compound | (min) | (kg mol⁻¹h⁻¹) |
| PE1F | DMMP | 144 | diiodine | 19 | 315 |
| PE1NF | DMMP | 144 | MeOH | 19 | 315 |
| PE2M | DMMP | 231 | MeOD | 46 | 172 |
| PE2NF | DMMP | 231 | MeOH | 46 | 172 |
| PE3M | DBMP | 173 | MeOD | 49 | 118 |
| PE3NF | DBMP | 173 | MeOH | 49 | 118 |

TABLE 2

| | | | | | Degree of | Labelled |
|---|---|---|---|---|---|---|
| | MₙNMR | Mₙ SEC | Ð | Chain | functionality | end per |
| Polymer | (g mol⁻¹) | (g mol⁻¹) | (Mw/Mn) | end | or labelling (%) | chain |
| PE1F | 1740 | 1640 | 1.48 | I | 87 | |
| PE1NF | 1400 | 1440 | 1.62 | H | — | |
| PE2M | 1250 | 940 | 1.45 | D | 91 | 1.82 |
| PE2NF | 1250 | 940 | 1.44 | H | — | |
| PE3M | 1630 | 1480 | 1.14 | D | 89 | 1.78 |
| PE3NF | 1630 | 1530 | 1.14 | H | — | |

TABLE 3

| | | Mg/Nd | | | |
|---|---|---|---|---|---|
| | Co- | mole | Protic | Time | Activity |
| Polymer | catalyst | ratio | compound | (min) | (kg mol⁻¹h⁻¹) |
| EBR1 | DMMP | 40 | MeOH | 145 | 94 |
| EBR2 | DMMP | 20 | MeOH | 112 | 134 |
| EBR3 | DMMP | 10 | MeOH | 86 | 193 |
| EBR4 | DBMP | 40 | MeOH | 175 | 64 |
| EBR5 | DBMP | 20 | MeOH | 129 | 101 |
| EBR6 | DBMP | 10 | MeOH | 105 | 153 |

TABLE 4

| | | | | Ethylene/1,3- |
|---|---|---|---|---|
| | Mₙ SEC | | Chain | butadiene |
| Polymer | (g mol⁻¹) | Ð | end | (mol %) |
| EBR1 | 9800 | 1.29 | H | 79.4/20.6 |
| EBR2 | 18000 | 1.23 | H | 77.9/22.1 |
| EBR3 | 33100 | 1.29 | H | 77.5/22.5 |
| EBR4 | 13600 | 1.37 | H | 80.1/19.9 |
| EBR5 | 20000 | 1.44 | H | 80.0/20.0 |
| EBR6 | 35620 | 1.65 | H | 79.9/20.1 |

1. Organomagnesium compound of formula (I) 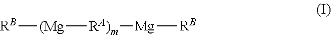
R^{B} being different from R^{A},
R^{B} comprising a benzene nucleus substituted with the magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl,
R^{A} being a divalent aliphatic hydrocarbon-based chain, interrupted or not with one or more oxygen or sulfur atoms or with one or more arylene groups,
m being a number greater than or equal to 1 and preferably equal to 1.

2. Organomagnesium compound according to claim 1, in which, if one of the two carbon atoms of the benzene nucleus of R^{B} ortho to the magnesium is substituted with an isopropyl, the second carbon atom of the benzene nucleus of R^{B} ortho to the magnesium is not substituted with an isopropyl.

3. Organomagnesium compound according to either one of claims 1 and 2, in which the carbon atoms of the benzene nucleus of R^{B} ortho to the magnesium are substituted with a methyl or an ethyl, preferably a methyl.

4. Organomagnesium compound according to any one of claims 1 to 3, in which the organomagnesium compound is of formula (II-m) 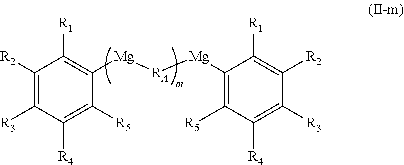
in which:
R₁ and R₅, which are identical or different, represent a methyl or an ethyl, preferably a methyl,
R₂, R³ and R₄, which are be identical or different, represent a hydrogen atom or an alkyl,
R^{A} is a divalent aliphatic hydrocarbon-based chain, interrupted or not with one or more oxygen or sulfur atoms or with one or more arylene groups,
m being a number greater than or equal to 1 and preferably equal to 1.

5. Organomagnesium compound according to claim 4, in which R₁, R₃ and R₅ are identical.

6. Organomagnesium compound according to either one of claims 4 and 5, in which R₂ and R₄ represent a hydrogen atom.

7. Organomagnesium compound according to any one of claims 1 to 6, in which R^{A} is a branched or linear alkanediyl, cycloalkanediyl or xylenediyl radical.

8. Organomagnesium compound according to any one of claims 1 to 7, in which R^{A} contains from 3 to 10 carbon atoms.

9. Organomagnesium compound according to any one of claims 1 to 8, in which R^{A} is an alkanediyl.

10. Organomagnesium compound according to any one of claims 1 to 9, in which R^{A} represents a linear alkanediyl.

11. Organomagnesium compound according to any one of claims 1 to 10, in which m is equal to 1.
